(19) United States
(12) Patent Application Publication
(10) Pub. No.: US 2012/0326402 A1
(43) Pub. Date: Dec. 27, 2012

(54) MACHINE TOOL

(76) Inventors: Burkhart Grob, Bad Woerhishofen (DE); Alfred Höbel, Lauben (DE)

(21) Appl. No.: 13/581,536

(22) PCT Filed: Mar. 1, 2011
(86) PCT No.: PCT/EP11/00990

§ 371 Date: Aug. 28, 2012

(30) Foreign Application Priority Data
Mar. 2, 2010 (DE) 10 2010 009 947.3
May 21, 2010 (DE) 10 2010 021 010.2
Sep. 8, 2010 (DE) 10 2010 044 781.1
Sep. 8, 2010 (DE) 10 2010 044 783.8

(51) Int. Cl. B23Q 3/06; B23B 31/28

(52) U.S. Cl. 279/134; 269/55

(57) ABSTRACT

The invention refers to a machine tool for the machining of one or more work pieces, wherein the work piece is held indirectly or directly by a clamping device in the machine tool on or at a non-rotary work piece table or a work piece table rotating around at least one axis.

The invention is characterized in that the clamping device comprises at least one clamping element interacting indirectly or directly with the work piece, and an electric motor is provided for generating the clamping power that is in operative connection with the clamping element.

The invention refers to a machine tool for the machining of one or more work pieces, wherein the work piece is held by a clamping device indirectly or directly in the machine tool on or in a non-rotatable work piece table, in particular a work piece table rotatable around at least one axis.

The invention comprises furthermore also a machine tool for the machining of one or more work pieces with a non-rotatable machining tool or in particular by a machining tool driven rotationally by a tool spindle, wherein the machining tool is held in a tool mount indirectly or directly by a tool clamping device.

The machine tools of this kind are, for example, part of more complex, in particular metal cutting machining lines, or also realized in preferably flexibly used machining centers. The machine tools of this kind have, as a rule, a high rotational speed of the metal-cutting machining tools. Also the other forces occurring during machining are actually considerable, so that for an exact machining of the work piece a reliable, exactly positioned fixing of the work piece to be clamped is required. The fixing is done here by a clamping device that has to carry off the considerable machining forces securely.

It is known here to attach the work piece either indirectly or directly to the work piece table or elements of the work piece table; a clamping device serves for that. When the work piece is attached directly, the clamping device acts directly on the work piece, when the attachment is indirect, the work piece is clamped, for example, on a work piece carrier or a pallet, and the clamping device interacts in a suitable way with the work piece carrier or the pallet. A clamping device for the work piece therefore requires, on the one hand, a positioning as exact as possible, on the other hand, a stability as high as possible, that is a high clamping power, to secure an highly accurate machining with as few rejects as possible.

The same, however, is required for the machining tool clamped in the tool mount of the machine tool.

It is known in the state of the art to hold or clamp the work piece to be machined (indirectly or directly) as well as also the machining tool for the machining (indirectly or directly) by hydraulic means.

Hydraulic clamping means have the advantage of developing high forces in a rather small space.

However, it is a disadvantage that installing the hydraulic lines that have to withstand a rather high pressure (several 100 bars) is expensive, and the hydraulic lines also require, because of the high stress, appropriate maintenance. The work piece table can be positioned for machining purposes in the space along at least one space axis, as a rule along several space axes. Therefore, the hydraulic line must be sufficiently flexible to be able to follow these motions in the space. However, often the work piece table can also rotate in the space, and also in these swiveled positions a reliable hydraulic supply has to be guaranteed what can be reached with these mentioned rotatable elements only with a considerable effort for construction as well as for maintenance.

Alternatively, the use of pneumatic work piece clamping systems is known, however, these do not reach such high holding forces.

There is also the problem that position interrogations, for example, is the work piece clamped or the machining tool clamped, can only be interrogated indirectly via the pressure or other expensive installations.

Eventually, also the effort for apparatus for installing the hydraulic arrangement is considerable, as besides a piping also an appropriate pump aggregate as well as valves and selecting of the valves are required.

Referring to this state of the art it is an object of the invention to suggest an improvement for the clamping of several elements, for example work piece or machining tool in machine tools.

In order to solve this problem a machine tool as described in the beginning is referred to, and it is suggested that on the work piece table an electromotor is provided the generated power, turning moment and/or angular momentum of which acts indirectly or directly on the work piece. Instead of a hydraulic or pneumatic drive now an electromotor is employed that operates the clamping device, or the electromotor interacts with a clamping element of the clamping device.

However, the knack is not only limited to the clamping of a work piece, but it can be used in the same way also for a tool clamping device. The tool clamping device comprises here at least one tool clamping element interacting indirectly or directly with the machining tool, and an electromotor is provided for generating the clamping power that is in active connection with the tool clamping element.

The suggestion allows, if necessary, to ban the complete hydraulic system from the machine tool. The suggestion according to the invention makes it in particular possible to use electric lines that can be handled much easier and that have to be guided in the also longitudinally moving or rotationally designed work piece table, what can be realized much easier by appropriate media lines, trailing cable devices and so on.

Basically, the suggested machine tool, however, still provides the option of realizing in special applications, nevertheless, a hydraulic clamping of the work piece (indirectly or directly) or the machining tool (indirectly or directly). Instead of providing a central hydraulic aggregate, locally, for example in the tool mount or on the work piece table, an appropriate hydraulic pump is operated by the electromotor that provides than in a suitable way the hydraulic acting clamping elements with the hydraulic medium with an appropriate pressure level.

It is a considerable advantage of the machine tool that it can be employed in this area very flexible, and the electromotor provides a universal source of power that is able to transmit via known mechanical components, such as gear, chains, pinion arrangement, toothed wheels, angular gear and so on, power and turning moment to the respectively required places. However, it is also possible to drive through the electromotor, for example, a hydraulic pump or pneumatic pump or other elements, and to use these sources of power and energy, respectively, then in a suitable way in the machine tool according to the invention.

Surprisingly, the concept does not only offer a considerable improvement of the clamping device, but enlarges considerably the field of use of a machine tool according to the invention. Through the suggestion according to the invention, the clamping process is improved considerably. Thus it is suggested that the clamping device comprises at least one clamping element interacting indirectly or directly with the work piece, and an electromotor is provided for generating the clamping power that is in active connection with the clamping element. The use of the electromotor in the work piece table, however, also allows a permanent rotation of the work piece. Thus, with a low effort the machine tool can be reset, and the electromotor serves then on the work piece table as rotational drive for the work piece, for example, for providing rotary grinding or turning machining on the work piece. For that, then the machining tool is clamped stationarily, for example, in a tool spindle set otherwise in rotation, and angled towards the work piece like in a turning lathe.

The following advantages occur in an arrangement, in the following also described as a mechatronical clamping device.

A machine equipped as described or its development has basically a high availability as it cannot only be used for conventional boring or milling machinings but also turning on a lathe machinings are possible with it.

The initiation of the clamping device is fast in combination with a feeding device.

The turning connections or turning distributions known in the state of the art for the hydraulic or pneumatic lines are avoided completely by the suggestion according to the invention. There is no wear of moved seals, turning and positioning of the work piece table is simpler and can be carried out with lower power.

Basically, the machine tool allows a fast reset of the machine to other work pieces and also other machining processes.

The suggestion allows realizing a control of the clamping power via the motor current consumed by the electromotor.

Leakage in the hydraulic system is avoided, and also the effort for maintenance for tightening the hydraulic screwing and so on is deleted. As no other hydraulic hoses have to be installed anymore, the hydraulic hoses do not need to be exchanged in regular exchange intervals, either. Also the rather high effort for deep hole borings in the basic slab of the device provided for receiving the hydraulic lines is deleted.

As by the suggestion in the work piece table a preferably rotating clamping drive is provided, very different clamping devices can be employed. It is, for example, possible to arrange single clamping elements, or to realize the clamping device as vise with three or multiple jaw chuck. Also a top spindle or the like can be used.

The suggested machine tool improves the environmental compatibility, as hydraulic oil is not required. Also a higher efficiency of energy is achieved.

According to a preferred modification it is provided that the motor shaft driven by the electromotor has an adapter connection serving for the optional connection of the motor shaft with a power transmission means for the clamping element(s) or for the connection of the motor shaft with a lathe chuck that serves for the indirect or direct receiving of the work piece for rotational grinding or turning machinings on the work piece.

Thus, the electromotor is configured stationarily in the work piece table, if necessary integrated in the rotary table. In this configuration, the electromotor performs as clamping drive for the clamping elements of the clamping device, even if the work piece, clamped on the work piece table, is rotated around a machining axis (rectangular to the clamping plane). The supporting slab carrying the clamping elements is configured such that its position can be defined exactly on the work piece table, however, it can be dismantled in a simple manner in order to dismantle also at the same time the clamping device carried by the supporting slab. As the electromotor remains stationarily, an adapter connection is provided as coupling that becomes loose when the supporting slab is lifted. For example, a lathe chuck can then be mounted on the adapter connection to receive thus a work piece and to supply it for a rotary grinding or turning machining.

Clamping of Work Pieces ($$11249)

According to a preferred modification, that, of course, can be realized also in connection with all, single or combinations of the other modifications, or single or several of the characteristics mentioned there, it is provided that the electromotor, preferably as center drive, drives several clamping elements via the at least one power transmission means. In this modification, the electromotor is arranged, for example, below the clamping plane, and a power transmission means can drive several clamping elements simultaneously. The effort for the electromotor and its cabling is rather low, however, it is more difficult to realize individual solutions with reference to the clamping power.

Accordingly, another modification, that can be realized, of course, also in connection with all, single or combinations of the other modifications, or single or several characteristics mentioned there, suggests that for each of the clamping elements an electromotor is provided as driving means for generating the clamping force. The single electromotors can now also be controlled by different powers or moments. The constructional size of the single electromotor can also be lower than, for example, for an electromotor as center drive. However, the invention comprises both modifications, and solve the problem of the invention excellently, and contribute to the before described positive effects.

An increase of the efficiency of the machine tool and its developments or embodiments and combinations of embodiments is accomplished, among others, also in that instead of complex hydraulic components one or more electromotor(s) is/are used as drive(s), in particular as indirect or direct clamping or turning drive(s).

It is seen here as favorable, if as drive an electromotor, in particular a servo motor, is used. This electromotor or servo motor can be designed, in particular, as synchronous, asynchronous or direct current motor. It is advantageous, if a servo motor is used, that its construction is compact, sturdy and that there is the option of an operation in a closed control circuit. The operation can be here moment controlled, speed controlled or position controlled.

It is seen as a favorable development when the drive is carried out via a sensorless synchronous or asynchronous motor. A permanent magnet excited synchronous motor (PMSM) is in particular preferred here. The suggestion comprises here in the same way the arrangement of the permanent magnet(s) as buried magnet(s) or as surface magnet(s) on the rotor, wherein the use of buried magnet(s) in the rotor is seen as particularly advantageous as mechanic stress occur in the bundle of laminations of the rotor and not on the surface. Additionally the loss is lower in the permanent magnet.

The use of permanent magnets on or in the rotor makes the excitation winding, otherwise present in synchronous machines, unnecessary.

It is seen as an advantage when sensorless motors are used, in particular synchronous motors, that here the additional arrangement of sensors or transmitters for the position definition of the rotor can be deleted, and the size of the construction is accordingly reduced. In the machine tools according to the invention or in the tool clamping devices or work piece clamping devices or turning devices provided in them the constructional space for the single components is narrow so that a structure of the entire machining center as compact as possible has to be realized. Besides the increase of the efficiency of the dynamic of conventional machine tools, the constructive size or the requirements of constructive size can be perfected through the use of sensorless motors with respect to the drive.

In an embodiment of the machine tool seen as favorable, that can be realized, of course, also in connection with all, single or combinations of the other embodiments or developments or single or several characteristics of these embodiments and/or developments, a sensorless definition of the rotor position, in particular a sensorless recognition of the standstill position is provided that can be realized in particular through the sensorless synchronous motor. Thus, in a sensorless synchronous motor, for example, the position of the rotor can be estimated by means of an anisotropy of the resulting inductance in the used stator coils of the stator. During the operation of the synchronous motor, depending on the rotor position in the stator coils, different resulting inductivities can be measured through which the position of the rotor can be estimated. It is seen as advantageous in this connection when the definition of the rotor position or the recognition of the standstill position can be carried out software—of NC-controlled. An appropriate integration in the machine control, for example a machine control comprising a micro controller, can be realized in a simple manner.

A favored option for defining the rotor position or the standstill position provides, for example, that measuring signals are superimposed to the select signal for connecting the stator currents for the stator coils in such a way that additionally to the driving magnetic field an alternating magnetic field is generated, wherein the current flows caused by the multi signals depend through the stator coils on the rotor position-depending, resulting inductance of the synchronous motor. The resulting inductance of the synchronous motor depends on the position of the rotor. The process for a sensorless definition of the rotor position is based here on the detection of the magnetic anisotropy of series and shunt inductance of the motor. If a fast alternating voltage is connected to the motor, the voltage in the pillar lane almost completely drops on the rotor position-depending inductance. The excited current is thus modulated by the rotor position, and can be evaluated accordingly. The strength of the signal is proportional to the difference of series and shunt inductance.

The input and output signals are processed by a control or measuring software or the NC-control, to define thus the rotor position or the standstill position. This again defines the tool application position or the work piece machining position or the position of the clamping element or clamping device for the work piece driven by an electric motor of this kind. If necessary, in the machine control a separate switching circuit or a micro controller programmed for it is provided for evaluating the rotor position.

The use of synchronous motors has other advantages besides the reduction of the constructive space required for the drive. Thus, the costs for installation are reduced altogether as sensor line, sensor and sensor interface are not required. The synchronous motors make a high dynamic and a slip-free motion possible. Besides the reduced space requirement, they also have a low weight, however, high efficiency and high flexibility. The position definition can be integrated in a simple way in the machine control of the machine tool according to the invention, resetting or retrofitting of existing machines is possible.

Another aspect of the machine tool and its possibly optionally combined developments is given by the fact that the electric motor is monitored by a control, preferably the control of the machine tool as NC-axis, wherein the control recognizes or derives because of these data the exact position or the exact location of the clamping element, and/or the control recognizes because of the determined data or because of the determined moment the imprinted or entered power of the clamping element(s). This modification of the invention is an advantage in the respect that now it is possible—in contrast to the so far expensive control installations for checking the corresponding position or the entered turning moments or the power—because of the monitoring of the NC axis or the electromotor and its parameters with reference to the energy consumption, to provide the required data in a simple way, and this is in the desired resolutions with respect to the single clamping elements. Through this also the effort of control and monitoring technology of a machine tool of this type can be reduced considerably by the use of an electromotor in connection with the control. Furthermore, the determined data are associated exactly with the single clamping elements what makes altogether a more favorable selection, if necessary, of the single elements possible.

It is an advantage, if, as means for power transmission, such as, for example, a timing belt, a chain or a gear is provided transmitting the power generated by the electromotor or the generated turning moment to the clamping elements or the clamping device. It is an advantage here, if, for example, a chain is guided from the electric motor to the clamping means over a pinion to transmit the forces there. The imprint of the power can then be determined either to the clamping means itself by elements integrated there or by directly imprinted power via the electromotor.

A possible solution is also provided wherein the electromotor is arranged on a motor shaft connection at the clamping device or the clamping means on the same axis of symmetry or parallel to it. Of course, also a modification is comprised where the electromotor is arranged angular, preferred rectangular, to the axis of symmetry of the clamping device or the clamping means.

Furthermore, it is provided and can be realized with all, single or combinations of embodiments of the machine tool according, that the clamping means has a free wheel, a clutch, designed preferably as sliding clutch, or the like to limit the power to be transmitted. Here, for example, the free wheel or the clutch as sliding clutch can be set in such a way that each clamping means imprints different forces or even identical forces. Of course, it is also possible to provide in the clamping means, for example, a spring or a spring assembly that generally acts in such a way that the necessary clamping power is generated. The electromotor then acts in interaction with the free wheel or the clutch in such a way that these are only used for releasing the work piece after finishing the machining, and imprint the necessary forces to move the spring assembly or the spring then in a lifted position. The same is, of course, also possible when instead of a spring a hydraulic cylinder is provided there that is arranged directly on or in the clamping means. This modification, however, will be discussed later on.

At least one clamping claw serving for clamping the work piece is provided on the clamping means. The clamping claw has the purpose of engaging on the work piece or on the tool in such a way that a certain positive locking connection exists, for example by appropriate recesses or grooves or channels on the work piece or the machining tool in which the clamping claw can engage. The pressure then pushes the work piece or the tool either on the machining table or in or on the tool mount.

As already mentioned it is an advantage that at or in the clamping element, preferably in the clamping means, a pressure-generating element, such as, for example, a pressure spring or a spring assembly is provided that in uncoupled state presses or moves the clamping claw in the clamping position, and in coupled state the electromotor moves the clamping claw in its initial or rest position. The initial or rest position is here the position in which the work piece can be removed.

According to a modification of the machine tool, that can be realized, of course, also in connection with all, single or combinations of the other modifications, or single or several characteristics mentioned there, it is furthermore provided that at or in the clamping means a pull-back element, such as, for example, a tension spring is provided that moves the clamping claw in uncoupled or not clamped state in an initial position. This is the reverse solution of the before described modification where the pressure spring or a spring assembly pressurizes the clamping claw during the clamping process, and the clamping claw has been moved back in an initial position by the power of the electromotor only for releasing. The now described modification shows the exactly reversed way, namely, for example, to load the pressure spring with tension, while the clamping claw clamps the work piece, and then in uncoupled state the tension spring returns the clamping claw in the initial position.

It has been found to be an advantage when the clamping claw has a nose-like designed clamping lug arranged in the direction of clamping facing the clamping plane angled, deviating 1° to 5°, preferably 2°, from the parallel to the clamping plane. This tilts the clamping claw or the clamping lug slightly in the direction of the work piece what improves the clamping process and makes the engagement of the clamping claw on the work piece easier, respectively. With reference to the axis of symmetry of the clamping element, the clamping lug is at an angle of about 90° to this axis of symmetry, with the already described deviation of 1° to 5°, or preferably 2°, then deviating from the 90° plane facing in the direction of the work piece.

It is also an advantage when the clamping claw can move essentially to the clamping claw. Thus, only an appropriate recess or groove where the clamping claw can engage has to be provided on the work piece or the work piece carrier carrying the work piece.

A development of the machine tool, that, of course, can be realized also in connection with all, single or combinations of the other modifications, or single or several of the characteristics mentioned there, provides that the clamping element is designed as collet chuck. Collet chucks are preferably always used when, for example, certain clamping means such as clamping bolts or the like are arranged, for example, on the pallet carrying the work piece or on the work piece itself, so that the collet chuck can embrace these clamping means. The solution with reference to the electromotor as drive for the clamping means can also be used in this modification.

Another convenient embodiment, that, of course, can also be realized in connection with all, single or combinations of the other embodiments or developments, or single or several characteristics of these embodiments and/or developments, suggests that the clamping element is designed like a truncated cone and has a mount in which a pin arranged in a pallet carrying the work piece or at the work piece to be machined is inserted for the clamping process. In up-to-date machining centers, where the machine tool can be employed, usually the pallets carrying the work piece are provided with these pins. In this case then the clamping element is designed correspondingly with these pins to embrace them and clamp for the machining process. A development of this suggests here, that the mount is embraced by a collet chuck that presses preferably the clamping clasps in clamped state against or towards the pin. This is an advantageous development that designs the entire clamping process even more efficiently.

It is also an advantage when the pin as clamping means has a pin head. Preferably, this pin head is formed in the pin. This pin head can be designed here at least partly ball-like or hemisphere-like or have appropriate curves or chamfers.

It is suggested, that the means for power transmission driven by the electromotor engages on the collet chuck. This can be, for example, an angular gear, a chain drive with chain and pinion or a timing belt with an appropriately designed pinion.

A favorable modification, that, of course, can also be realized in connection with all, single or combinations of the other modifications, or single or several of the characteristics mentioned here, also provides that the clamping elements and/or the collet chucks are designed hydraulically acting, wherein the pressure-generating hydraulic pump is provided directly at or in the clamping element or at or in the collet chuck. In the beginning, the advantage of such a solution has already been described as it is not necessary in such a design to supply the expensive hydraulic aggregates or to connect them by pipes or hoses. According to the solution, the electromotor drives a hydraulic pump generating pressure that is arranged directly in or at the clamping element.

Thus, only a connection from the hydraulic pump, if necessary, to the pressure cylinder, at the clamping means has to be produced that can be provided directly as bore hole in ₜhe clamping element or in the collet chuck. Thus, quasi the hydraulic element is installed in the last possible element during the clamping process, namely in the collet chuck or in the clamping means itself. The expensive piping and/or providing of suitable hose connections, distributors and the like is deleted completely. It is not necessary here, either, to provide suitable, flexible elements that have to compensate swiveling of the machining plane. Nevertheless, the hydraulic system provides, as a rule, slightly higher pressure for clamping the work pieces.

Accordingly, the solution achieves that at or in the clamping element a hydraulic pump is provided acting independently from a central hydraulic aggregate and generating directly at or in the clamping element the required contact pressure for clamping the work pieces or the tools. This is a very advantageous solution because—as already mentioned—the high contact pressure can be generated directly in or at the clamping element.

It is seen as favorable to provide a control for the clamping power through which the exact clamping of the work piece is monitored. It is also possible here to enter or supply different clamping forces at different clamping elements. This is also achieved through the clamping power control. Furthermore, it is, of course, also possible because of the clamping power control, to determine the exact clamping of the work piece to be machined or the machining tool.

Up-to-date machining centers and machine tools work with a so-called zero point clamping device. Generally, here certain points of the article to be clamped are given to get an exact positioning or orientation of the work piece at or on the machining surface. Accordingly, an advantageous development of the machine tool, that, of course, can be realized also in connection with all, single or combinations of the other embodiments or developments, or single or several characteristics of these embodiments and/or developments, is characterized in that this zero point clamping device is provided for an exact positioning or orientation of the work piece at or on the machining surface. Of course, the corresponding means also have to be provided on the respective work piece. During positioning or orientation of the work piece, it is then recognized because of this additional means, whether the work piece to be machined is positioned correctly. If it is, for example, not positioned correctly, for example, because of the control devices for the clamping control it can be checked whether all clamping means have exactly the required tension. If this is not the case, the result will be that releasing and positioning have to be carried out one more time, before the clamping process is repeated again. It is also an advantage, if on the clamping means or in its immediate vicinity and/or on the machining surface or the clamping surface at least one reference surface is provided for determining and/or testing the exact positioning of the work piece or the pallet carrying the work piece. Determining the exact positioning and, if necessary, readjusting the clamping process can be accomplished with slightly less effort by the reference surface than described before.

Furthermore, it is an advantage here if on the work piece and/or on the clamping surface at least one clamping nipple is provided serving, on the one hand, for positioning the work piece on the clamping surface, however, also serving at the same time for clamping the work piece on the clamping surface additionally or alternatively. Of course, there is now the chance, because of the clamping nipples, of determining their position, whether the work piece to be machined is positioned just exactly, what is very decisive for the accuracy of machining.

It is another advantage here when at or in the clamping nipple at least one identification means with information about the work piece and/or machining of the work piece, such as, for example, a data carrier, transponder or bar code is provided. Here a sort of a multiple use is provided by the fact that, on the one hand, through the clamping nipples, of course, the exact positioning can be carried out, on the other hand, at the same time information is available whether the work piece to be machined is the correct one that is required for machining right now, and, in particular, also information about the machining of the work piece is available that then can be used for machining. Accordingly, here a very clever modification is provided that increases the effects of the invention considerably.

This data carrier can be arranged here additionally or alternatively, for example, with a separate fastening means on the clamping nipple. As fastening means here, a screw can be used as well as the usual gluing or providing of appropriate grooved pins fastening the identification means or the data carrier.

A modification, that, of course, can also be realized in connection with all, single or combinations of the other modifications, or single or several of the characteristics mentioned there, provides that the motor shaft driven by the electromotor has an adapter fitting serving for the optional connection of the motor shaft with a means for the transmission of power for the clamping element(s), or for the connection of the motor shaft with a lathe chuck that serves for the indirect or direct receiving of the work piece for rotary grinding or turning on a lathe machinings on the work piece.

Thus, the electromotor is designed stationary in the work piece table, if necessary, also integrated in the rotary table. In this design the electromotor performs its function as clamping drive for the clamping elements of the clamping device even if the work piece, clamped on the work piece table, is turned around a machining axis (rectangular to the clamping surface). The supporting slab carrying the clamping elements is designed in such a way, that its position can be defined exactly on the work piece table, but in a very simple way also can be dismantled to remove at the same time also the clamping device carried on the supporting slab. As the electromotor remains stationary, an adapter fitting is provided as coupling that is then released when the supporting slab is lifted. For example, a lathe chuck can then be mounted on the adapter fitting to receive the work piece and to supply it for a rotary grinding or turning on a lathe machining.

Clamping and Machining of Work Pieces and Adapter Fitting ($$11254)

It is also an object of the present invention to widen the field of application of before mentioned machine tools.

Referring to a machine tool—as described in the beginning—it is suggested that the work piece carrier has a drive shaft driven by a drive, and the drive shaft has an adapter fitting for optional connection of the drive shaft with a power transmission means for a clamping device serving for the indirect or direct clamping of the work piece, wherein the drive in this case of application serves for operating the clamping device or for the alternative connection of the drive shaft with a lathe chuck serving for the indirect or direct receiving of the work piece for rotational grinding or turning machining of the work piece, and the drive serving in any case of application for rotating the work piece.

The suggestion widens the field of application of the known machine tools considerably. Besides the known metal-cutting machining by an usually rotationally driven machining tool, now also a turning machining is possible. As a rule here the machining tool itself rests, however, because of the NC-controlled axis of the spindle it can be positioned along one, two or three space axes relatively to the work piece. Therefore the machining tool does not rotate (necessarily) in this case of application, but can nevertheless be moved along the axes and be positioned.

An essential advantage is here in particular the fact, that thus all accuracy features known for a metal-cutting machining with rotary machining tool can also be used immediately in a turning on a lathe machining.

The embodiment is realized here such, that the effort for resetting is very low, and the respectively other purpose of use is realized with a quick remodeling on the work piece carrier. In order to carry out this quick remodeling, it is seen as convenient when the adapter fitting is configured as quick connection link, quick coupling, claw coupling, screw connection or bayonet connector, however, it does not remain restricted to the before mentioned embodiments of an adapter fitting. Rather all possible connection types can be employed here that are seen as useful and compatible with the machine tool. The object is always to provide a connection here that allows only with a few licks of the wrist, preferably automatically, an exchange of the means of power transmission of a clamping device serving for the indirect or direct clamping of the work piece for a lathe chuck.

If the means for power transmission for the clamping device serving for the indirect or direct clamping of the work piece is arranged on the adapter fitting, the drive shaft acts here on the means for power transmission. The work piece carrier is here designed preferably stationarily in the space.

However, if via the adapter fitting a lathe chuck is arranged, here via the adapter fitting a direct connection of the drive shaft to the lathe chuck is carried out so that a work piece received in the lathe chuck, that means clamped or fixed in any other way, can be moved rotationally. A machining tool angled against the work piece that can be positioned preferably along one, two or three spatial axes relatively to the work piece then removes in a turning on a lathe or grinding process material from the work piece and thus effects its deformation. Both cases of application thus can be realized in the same machine.

The driving motor is here designed stationarily in a work piece table, if necessary integrated in a rotary table. Via the adapter fitting on the drive shaft, the driving motor designed preferably as hydraulic or electromotor then fulfils its function as clamping drive for the clamping elements of the clamping device, if in the machine tool a clamping device is used for fixing the work piece. If the clamping device is removed, the driving motor remains in the work piece table, and the adapter fitting is free for receiving, for example, a lathe chuck or another receiving device for a work piece for its rotary grinding or turning on a lathe machining. The driving motor then drives the lathe chuck or the work piece clamped or held in it, and sets it is rotary motion.

There is the option and it is seen as favorable for the driving motor to be provided as electric or hydraulic motor, as described before. The motor serves for driving the drive shaft that acts in a first embodiment or development of the machine tool on the means for power transmission for the clamping device serving for the indirect or direct clamping of the work piece. In the second alternative design of the machine tool that is realized on one and the same machine base, the drive shaft or the motor driving it serves for realizing a rotational motion of the work piece or a lathe chuck receiving or holding the work piece, or the like. Means for fixing the work piece to be machined in the lathe chuck then are arranged in it, and are, if necessary, operated independently from the drive of the lathe chuck by suitable actuators.

An increase of the efficiency of the machine tool is accomplished by using instead of complex hydraulic components, one or more electromotor(s) as drive(s), in particular as indirect or direct clamping or rotational drive(s) in all possible embodiments as well as combinations of them.

It is seen here as favorable, if as drive, as discussed before, an electromotor, in particular a servo motor, is configured. This electromotor or servo motor can be designed, in particular, as sensor-less synchronous, asynchronous or direct current motor. It is advantageous, if motors of this type are used, that its construction is compact, sturdy and that there is the option of a closed control circuit. The operation can be here moment controlled, speed controlled or position controlled.

A preferred embodiment of the machine tool, that can be employed, of course, also together with other embodiments or single characteristics combined in a machine tool, provides that here a work piece carrier that is stationary in the space is provided, and a rotation of the work piece arranged on the work piece carrier is carried out together with the work piece carrier so that a machining of the work piece from several sides can be carried out. Of course, there is also the option that the tool carrier as well as also the work piece carrier is designed movable or rotary along at least one or more axes so that the possible machining positions are multiplied.

It is also seen as favorable, and as possible to be realized in connection with all before and later mentioned embodiments of the machine tool or single embodiments, if the work piece carrier can be moved and/or rotated along at least one axis. In order to achieve a machining as flexible as possible, the work piece can be designed in such a way that it can be positioned at three spatial axes relatively to the machining tool. Besides the longitudinal axes, however, also rotational axes are provided. The rotational axes make rotating the work piece carrier around a, for example horizontally orientated, rotational axis possible. Besides, there is also the option, when the work piece carrier is suitably movable or rotary, rotating the work piece also around a vertically orientated rotational axis. For that, also the drive for the means for power transmission for impinging the clamping device serving for the indirect or direct clamping of the work piece can be used for the rotational movement of the complete work piece carrier. For that, then appropriate couplings can be arranged in the clamping device, so that after clamping the work piece, the drive shaft or the drive itself is available for a rotation of the work piece carrier around the vertical rotational axis.

It is seen as advantageous, in particular in connection with all, single or combined embodiments of the machine tool, when the drive acts directly on the drive shaft. Besides, there is, of course, also the option that the drive acts only indirectly, for example via a gear or the like, on the drive shaft. Besides the use of a gear, of course, all other possible types of power transmission from drive to drive shaft are employed, if this is seen as useful and can be realized with respect to the geometry of the machine and the desired purpose of use. If the power is transmitted via a gear, there is also the option of using a driving motor for the drive of different clamping devices, for example of several lathe chucks.

A preferred embodiment of the machine tool, that can be realized not only separate, but also in combination with one or more other preferred embodiments, or one or more characteristics of them, provides that the clamping device that can be operated via the drive shaft of the machine tool has a supporting slab carrying the work piece, and the supporting slab is supported on several points on the work piece carrier. Of course, the supporting slab can also be connected releasable fixedly with the work piece carrier. Here then suitable fastening means, for example screw connections or the like, have to be used to achieve an accurately and reliably positioned connection between supporting slab and work piece carrier. On the supporting slab itself supporting points can be provided for the work piece making an exact positioning of the work piece possible. Thus, a highly accurate positioning of the work piece is reached so that the clamping device can engage on clearly defined points of the work piece to clamp it against the supporting slab or the supporting points.

Another preferred embodiment of the machine tool or a combination of single or several advantageously developed embodiments of the machine tool provides that the clamping device has at least one clamping element. This clamping element can be operated here via means for power transmission provided in the clamping device, and serves for fixing the work piece. Thus the clamping elements can have, for example, clamping claws provided longitudinally movably on the clamping element. These clamping claws engage in a defined position on the work piece, and push it to the supporting slab during machining. Of course, here also other cramping or clamping means can be used additionally or alternatively to the clamping claws.

An embodiment of the machine tool seen also as favorable, that, of course, can be realized also in connection with all, single or combinations of the other embodiments seen as useful of the machine tool, provides that for operating the before-mentioned clamping elements a means for power transmission is provided connecting the clamping elements with a central drive. This central drive is again connected, for example via the adapter fitting, with the drive shaft that then, again via the means for power transmission, effects the operation of the clamping elements or the clamping means arranged or shifting on them, and thus eventually clamping of the work piece. For connecting the means for power transmission with the central drive or for power transmission from the central drive to the clamping elements, for example, a chain, a belt or a suitably designed gear can be provided the driving pinion of which can comb (?), on the one hand, with the drive shaft or the adapter fitting arranged or provided on it, and, on the other hand, with another pinion provided for example on a spindle of the clamping element, and thus carries out an operating of the clamping elements or the clamping means arranged on it. In order to prevent an excessive clamping which might damage the work piece, the gear described here can be designed with a sliding clutch. Monitoring the power consumption of the driving motor makes it possible to monitor the single clamping states of the clamping elements, and to influence them accordingly. Reversing the driving direction of the driving motor realizes releasing or fixing the work pieces by a suitable operating of the clamping elements or the clamping device.

When the clamping device is exchanged for a lathe chuck, in one or more possible embodiments or combinations of them, it is preferably provided that the chuck body receiving the rotating part of the lathe chuck is connected fixedly with the work piece table to provide here a reception or a bearing for the rotating part of the lathe chuck. The chuck body connected fixedly with the work piece table has on its inside then at least one bearing for the rotating part of the lathe chuck, that means the actual spindle, connected via the adapter fitting with the drive shaft. The spindle of the lathe chuck has clamping means for holding the work piece that has to be set in rotation.

To be able to carry out a fixing of the chuck body complying with the high occurring forces, this has appropriate connecting means that can engage with the work piece table. The rotating part of the lathe chuck is then connected via a connecting means penetrating through the work piece table with the adapter fitting on the drive shaft, and can thus be rotated via this.

In the case that a clamping device as described before is arranged on the work piece table as well as in the alternative embodiment with a lathe chuck it is seen as favorable if the adapter fitting is located between the supporting points or in the surface defined by the supporting points. Thus then a highly accurate centering of adapter fitting and means for power transmission of the clamping device or the lathe chuck becomes possible. However, this embodiment is so not seen as separate, but, of course, can be realized in connection with other embodiments as well as single characteristics, combined with preferred embodiments.

It is seen as particularly advantageous in connection with all embodiments or combinations thereof, if the lathe chuck is supported on the work piece carrier, wherein the work piece carrier or a rotary table provided on it provides a sliding surface for the lathe chuck. This is the simplest way of using the machine tool according to the invention with a lathe chuck. Here only the clamping device with the supporting slab carrying the work piece and means for power transmission are removed from the work piece carrier by releasing the corresponding connecting means connecting the supporting slab with the work piece carrier, and the means for power transmission with the drive shaft or the adapter fitting arranged on it. Then the work piece carrier is ready for arranging the lathe chuck. This is then arranged via suitable coupling points on the drive shaft or the adapter piece or adapter fitting, and is then ready for clamping work pieces and for the rotary machining. The lathe chuck itself is here supported on the work piece carrier that then provides the sliding surface. Via suitable lubricating points, also a lubrication of the lathe chuck can be provided.

Another preferred embodiment of the machine tool, that, of course, can be realized also in connection or in combination with all, single or other combinations plus preferred embodiments, provides that the lathe chuck has a chuck body and a rotating spindle. The chuck body is supported here in particular on several supporting points on the work piece carrier, while the spindle is supported pivoted in the chuck body. The chuck body forming a bearing for the spindle is here connected releasably fixedly with the work piece carrier. This connection can be carried out by engagement and/or screwing of chuck body or lathe chuck and work piece carrier or rotary table or in another suitable way. The spindle supported in the chuck body is connected with the drive shaft for which purpose again an appropriate adapter fitting, that may be designed for example as quick connection link, quick coupling, claw coupling, screw connection or bayonet connector, is provided. Through this then a particularly fast and simple resetting of the machine tool is possible so that the work piece carrier is not only available here for a stationary or almost stationary arrangement of work pieces for machining by rotating tools, but rather also the chance is created of providing work pieces or clamping means, that is clamping or lathe chucks, that allow a machining when the work piece rotates.

In the machine tool described before or in favorable embodiments or developments a fixing of the work piece in the lathe chuck is provided to carry out here a machining when the work piece rotates. For fixing the work piece in the lathe chuck, here, in particular, a mechanic, hydraulic, pneumatic electric-mechanic, electric-magnetic clamping of the work piece is provided in the lathe chuck. Suitable clamping means acting on the jaws of the lathe chuck or the work piece can be accommodated here, for example, in the chuck body. The chuck body can have here, for example, a stationary part with the appropriate clamping means or the drives for these clamping means. The chuck then has the required operating means for this.

Another favorable embodiment of the machine tool, to which, however this does not remain restricted, but can be developed additionally by combination of other embodiments, provides a common control for the before described cases of application, that means for the use of a clamping device for the stationarily fixing of a work piece as well as for the use of a machine tool for machining a rotating work piece. It has been proven as particularly favorable when for that a separate control is provided in the machine tool, or the control is provided for the respective cases of application, that is for operating the clamping device or the lathe chuck through the control of the machine tool. Conventional machine tools have sufficient resources to integrate here additional controls in already existing machine controls, and via operating elements, provided as a rule on the machine tool or its control, to associate another control with the corresponding elements of the machine tool.

In connection with the control provided in the machine tool or the developments of the provided control, it is seen as convenient if the clamping of the work piece in the clamping device and/or in the lathe chuck can be controlled by the control. Here, clamping parameters, such as clamping pressure, clamping speed and the like, can be controlled by the control and thus a perfect centering of the work pieces as well as the perfect use of the machine tool can be carried out. The machining parameters, such as, for example, the use of the tool, angling the tool on the rotating work piece or releasing or clamping the work piece in the clamping device, that also can be used in the machine tool, can be controlled.

Another advantageous embodiment of the machine tool, that can also be realized in connection with other advantageous developments of the machine tool, is characterized in that a fixing or releasing of the clamping device or the lathe chuck and/or the clamping jaws arranged on it can be carried out automatically, manually or only partly automatically or partly manually. The machine tool or suitable elements provided in it then effect a fixing or releasing of the clamping device or the lathe chuck if this is preset, for example, by the control. Besides, there is also the possibility that a user interferes here and triggers or operates a corresponding mechanical system for fixing or releasing the clamping device or the lathe chuck, and, after that, removes the corresponding machine parts manually or inserts them in the corresponding mountings.

In connection with the automatic or manual fixing or releasing of the clamping device a preferred embodiment of the machine tool and the combination of embodiments, respectively, provides that here an automatic or manual engagement of the adapter fitting in the clamping device and/or the lathe chuck is provided. This engagement can also be realized through the machine control, however, there is also the option that here the adapter fitting is operated appropriately.

It is seen as favorable if the adapter fitting has means for fixing and/or releasing the clamping device or the lathe chuck. Means of this kind can be, for example, the already mentioned quick connection links, a quick coupling, a claw coupling, a screw connection or a bayonet connector. These again can be operated manually as well as automatically. The means are here accessible for the user in such a way that a manual operation is possible.

Because of the before mentioned automatic as well as manual operation provided by the machine tool it, can be used in many ways, and is suitable for the embodiment as small, medium or large machine, that means for the large scale use as well as for a use in a small series production or in even smaller business.

Thus the machine tool is useful in many ways, and allows a more efficient use of the machine tool.

Machining Tool ($$11244)

What is provided here is machining one or more work pieces with a machining tool, wherein the machining tool is held in a tool mount of a tool spindle of the pre-mentioned machine tool indirectly or directly by a tool clamping device, and the tool clamping device comprises at least one tool clamping element interacting indirectly or directly with the machining tool.

The machining tool as described in the beginning has also an electromotor and a spring arrangement that is in operative connection with the tool clamping element, or at least one means driven by the electromotor acts on the spring arrangement for releasing the machining tool from the tool clamping device.

In known machine tools usually the tool clamping is released hydraulically, or releasing of the machining tool held by a spring arrangement is effected by a hydraulically operated cylinder or the like. The employment of hydraulic technology has the advantage that with the hydraulic components in a rather small space high forces can be generated.

However, it is a disadvantage that the installation of hydraulic lines that have to withstand an appropriate high pressure (several hundred bars), is, for once, expensive and also requires appropriate maintenance. The use of hydraulic system therefore is rather expensive. The suggestion of using an electric motor as power medium instead of a hydraulic arrangement, banishes the entire hydraulic system from the area of the tool spindle with considerable advantages for the production of the machine, as well as also for service and maintenance. If necessary, it is also used that by a clever arrangement of the gear an electromotor can generate high forces.

Another suggestion for increasing the efficiency of the machine tools proposes that the tool spindle has a drive that fixes the machining tool along an operative direction via a tension element.

As already described in the beginning, a tool spindle often covers the rotary drive of a machining tool, such as, for example, of a drill or milling cutter. However, the term “tool spindle” does not hint to that solely. Through the suggested machine tool, another purpose is added to the metal-cutting machining function of the tool spindle realized by the auto-rotation of the machining tool. By fixing the machining tool on the spindle, for which a drive of the tool spindle serves acting on the machining tool along an operative direction via a tension element, the machining tool is locked exactly positioned and stably positioned, respectively, and acts, like during a turning on a lathe machining, as stationary, non auto-rotary lathe tool, that, nevertheless, because of the one or multiple axis movement realized preferably on the tool spindle, can be positioned in the space with reference to the rotary work piece in any way.

By realizing a second machining type in the machine tool, besides the known auto-rotary use of the machining tool, now also the function of a lathe is possible. The consequence of the suggestion is a considerable increase of efficiency.

Favorably, it is provided that the machining tool can be fixed axially with reference to the longitudinal axis of the tool spindle in all embodiments described here. The tool spindle is often configured rotary, and the longitudinal axis of the tool spindle covers at the same time also its rotational axis. The machine tool has the purpose of using a rotary employed tool spindle as holding device for a lathe tool. Additionally, it is favorably also provided to fix the machining tool in the direction of the circumference with respect to the longitudinal axis of the tool spindle. This is realized by an appropriate support of the turning moment, for example by a pin projecting in a boring of the spindle head or a similar arrangement in the pivot or rolling bearing.

Advantageously it is provided that, depending on the position of the tension element preset by the machine control and effected by the drive, the machining tool in the tool spindle serves for an auto-rotary, metal-cutting machining as rotating cutting tool (for example as drill or milling cutter) or a non auto-rotary, metal-cutting machining as lathe tool.

It is provided that the machine control acts in a suitable way on the drive, and thus influences the position of the tension element. It is also provided that the tension element is shifted in operative direction to fix thus the machining tool. Thus, the use of the machine tool as lathe is provided, and the machining tool is used in a non auto-rotary, nevertheless, metal-cutting machining as lathe tool. Therefore, it is provided on the machine control to position the tension element via the drive in another way, and in particular not to fix the machining tool. Thus, an auto-rotary and also metal-cutting machining of the machining tool, for example as drill or milling cutter, is possible.

Preferably it is provided that the tool mount is supported pivoted around a rotational or longitudinal axis in a pivot bearing, and the fixing of the machining tool is carried out by a movement of the tool mount axially with reference to the rotational or longitudinal axis, in particular in ₜhe pivot bearing.

The pivot bearing provided for the tool mount has, seen in axial direction, a certain, however slight, elasticity or a free motion. This flexible quality is the result of the construction of the pivot bearing and the arrangement of the rolling elements in the rolling bearing or pivot bearing. The locking power imprinted by the drive in operative direction is here larger than the tension force of the rolling bearing, that is usually rather small, so that the pivot bearing is fixed, and thus there is no more turning movement of the machining tool around the rotational axis, either. In this concept, fixing of the machining tool is carried out indirectly as the rotational motion of the tool on the tool mount is fixed.

In another concept, that can be realized alternatively, parallel or in combination with one or several characteristics, or one or several embodiments of the machine tool, the machining tool has a supporting device through which the fixed machining tool is supported on the spindle head. In this concept, there is no compulsory axial stress of the pivot bearing. The supporting device is formed, for example, by a supporting collar provided on the machining tool or by a supporting slab carrying, for example, supporting pins, through which the machining tool can be supported on the spindle head, the front end of the tool spindle. It is therefore possible, that the supporting device can be designed variably, and not only be configured reduced to the modification according to the enclosed figure. Different embodiments can be realized, for example a protruding spring engaging in a corresponding groove and resulting in a support of the turning moment (fixing in direction of the circumference) as well as also in an axial support.

In a preferred embodiment, that, of course, can also be realized in connection with all, single or with combinations of other embodiments, or their characteristics, it is provided that as drive an electromotor or a hydraulic drive or a hydraulic motor is provided. The machine tool that can be used in two different ways of machining allows the alternative or parallel use of an electromotor and/or a hydraulic drive as drive. As in particular an axial pull-back movement of the machining tool relatively to the tool spindle is decisive, such a pull-back movement or operative movement, can, for example, also be realized by a hydraulically impinged piston in an arrangement such as a working cylinder. The rotary motion of the rotor of an electromotor is here translated in an axial motion by a ball screw spindle.

An increase of the efficiency of the machine tool or its embodiments and advantageous developments is accomplished in particular by using one or more electromotor(s) as drive(s), in particular as indirect or direct clamping or rotational drive(s) instead of complex hydraulic components.

It is seen here as favorable, when as drive an electromotor, as described before in connection with the work piece clamping, is used, in particular a servomotor. This electromotor or servomotor can be configured in particular as synchronous, asynchronous or direct current motor. The advantage when using servomotors is their compact and sturdy construction, and the option of operating in a closed control circuit. The operation can be here moment controlled, speed controlled or position controlled.

It is seen as a favorable development of the machine tool as well as one or more embodiments or combinations of embodiments, or characteristics of the embodiments, when the drive is carried out via a preferably sensorless synchronous or asynchronous motor. The suggestion comprises here in the same way the arrangement of the permanent magnet(s) as buried magnet(s) or as surface magnet(s) on the rotor, wherein the use of buried magnet(s) in the rotor is seen as particularly advantageous as mechanic stress occurs in the bundle of laminations of the rotor and not on the surface. Additionally the loss is lower in the permanent magnet.

With respect to the use of the mentioned motors the preceding description is referred to in order to avoid repetitions.

The before described embodiments develop the subject matter separately, in combination and/or in combination of one or more characteristics of the embodiments, and serve for solving the problem set out in the beginning.

The suggestion allows positioning the work piece not only, as on a rotary table, around a rotational axis, but to set it in rotation to make machining possible.

The rotational grinding and turning machining comprises here machinings on the work piece circumference as well as on the inside or front side.

In the drawing the invention is shown schematically in particular in an embodiment. In the figures:

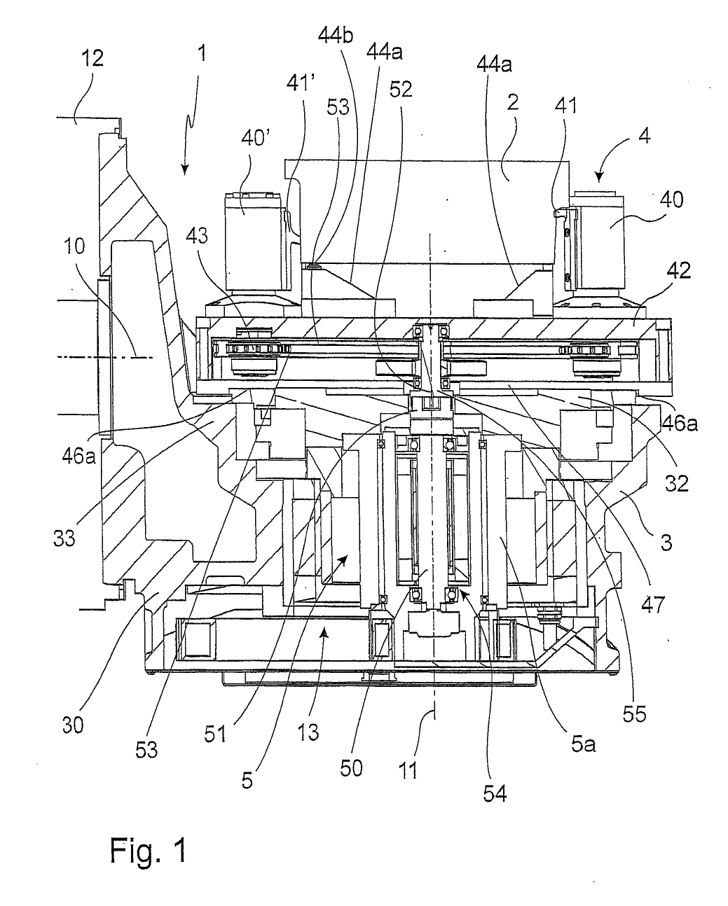

FIG. 1 a side view of the machine tool according to the invention

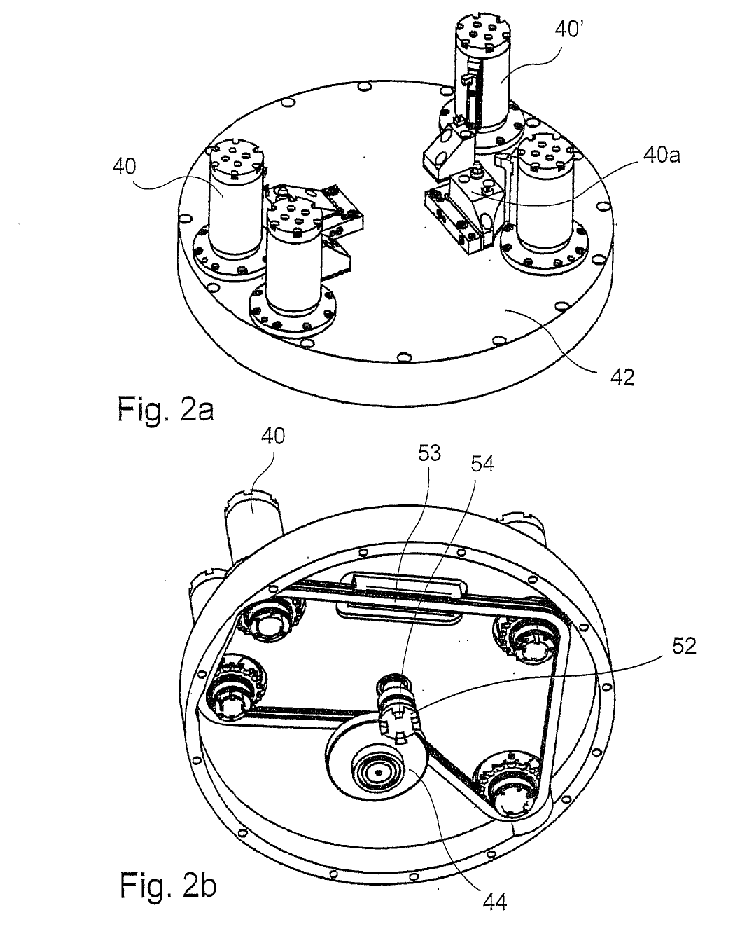

FIGS. 2a, 2b each in a three-dimensional view (FIG. 2a top view, FIG. 2b bottom view) the supporting slab of the machine tool according to the invention

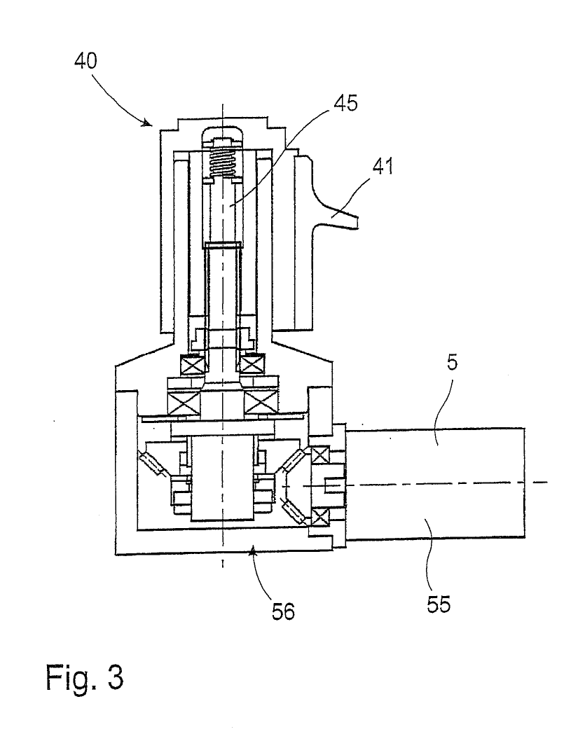

FIGS. 3, 4, 6, 7 each in a view of different embodiments of the clamping element according to the invention

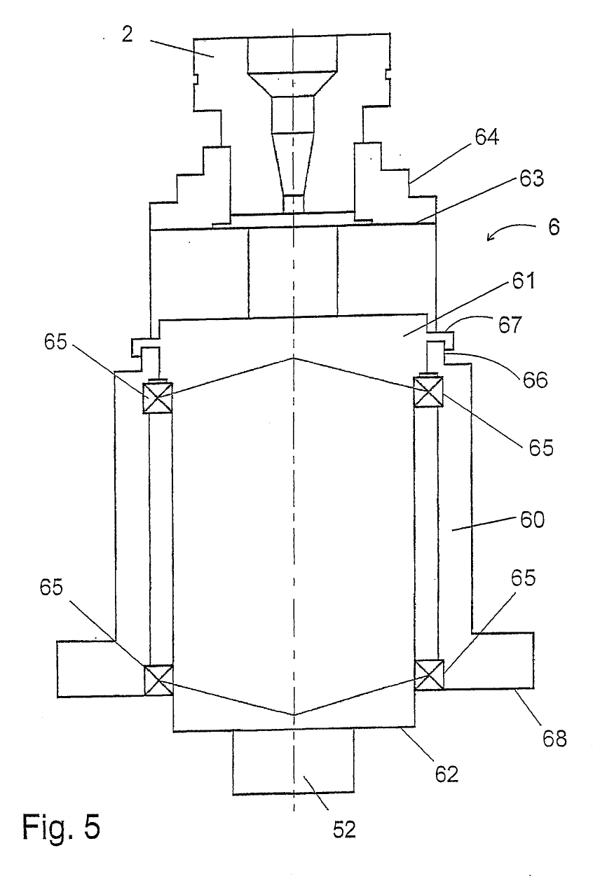

FIG. 5 a lathe chuck for use in the machine tool in side view

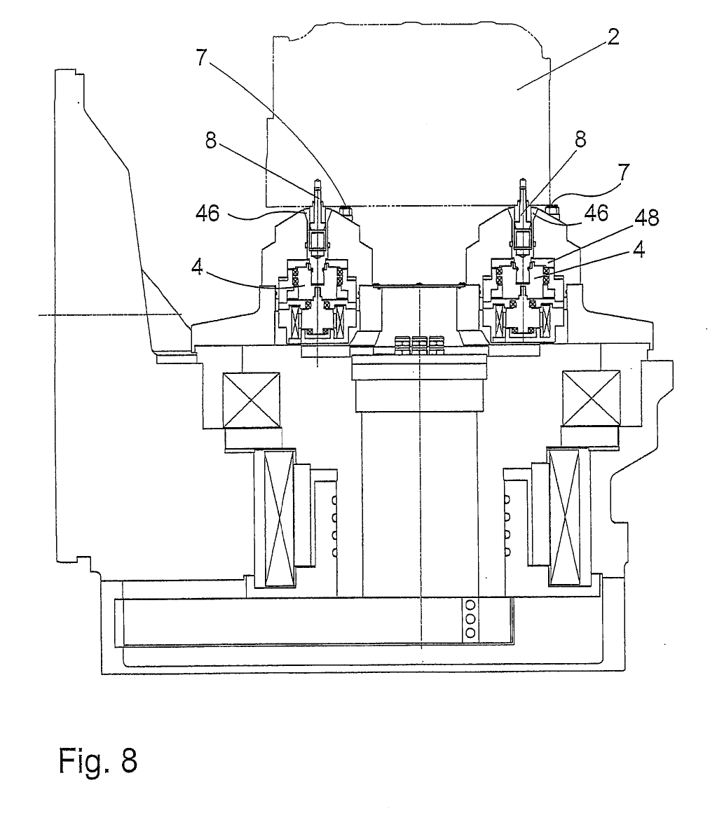

FIG. 8 a side view of another embodiment of the machine tool according to the invention with zero point voltage,

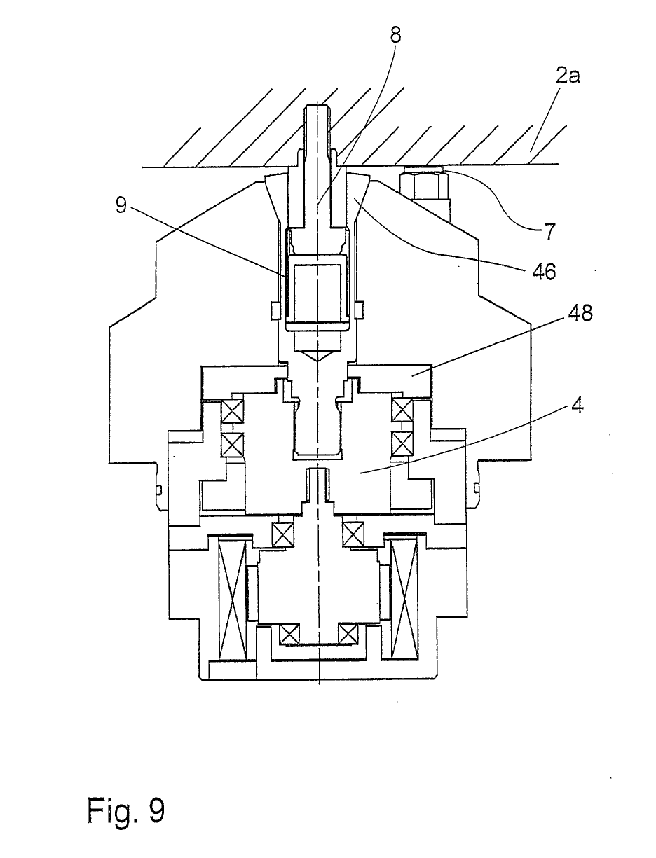

FIG. 9 detail of FIG. 8.

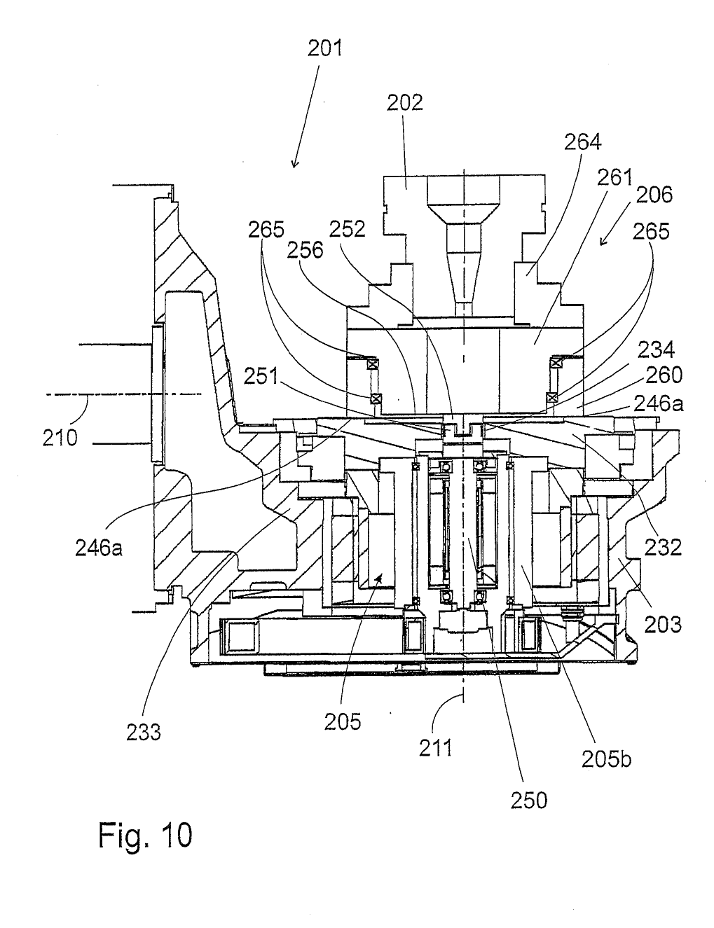

FIG. 10 a side view of another embodiment of the machine tool according to the invention.

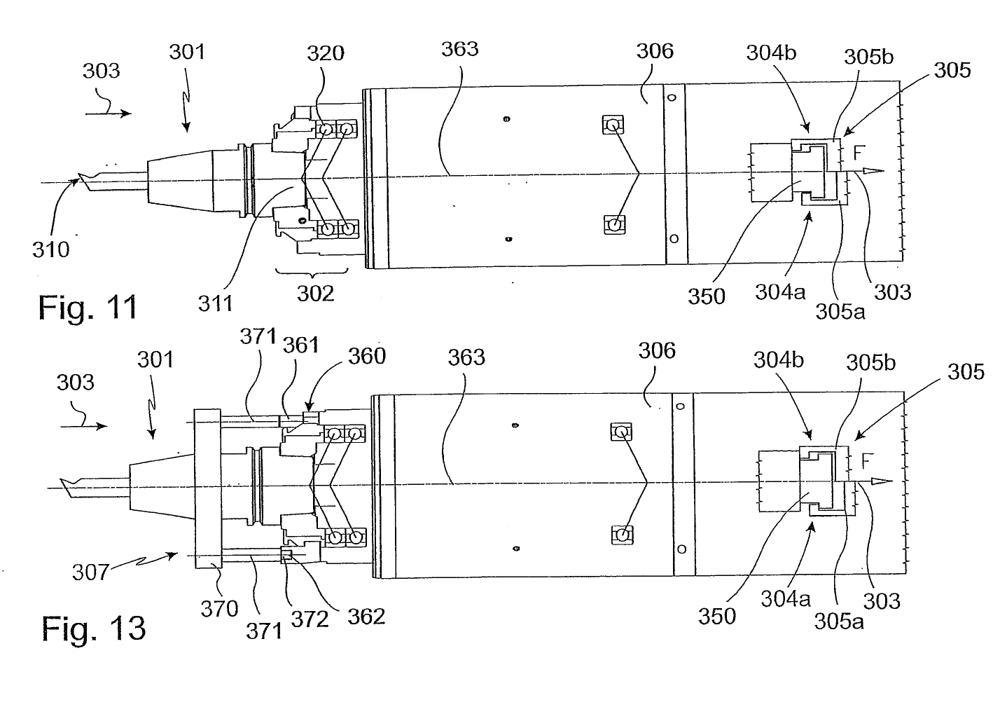

FIGS. 11, 12, 13 each in a side view the tool spindle of a machine tool according to the invention.

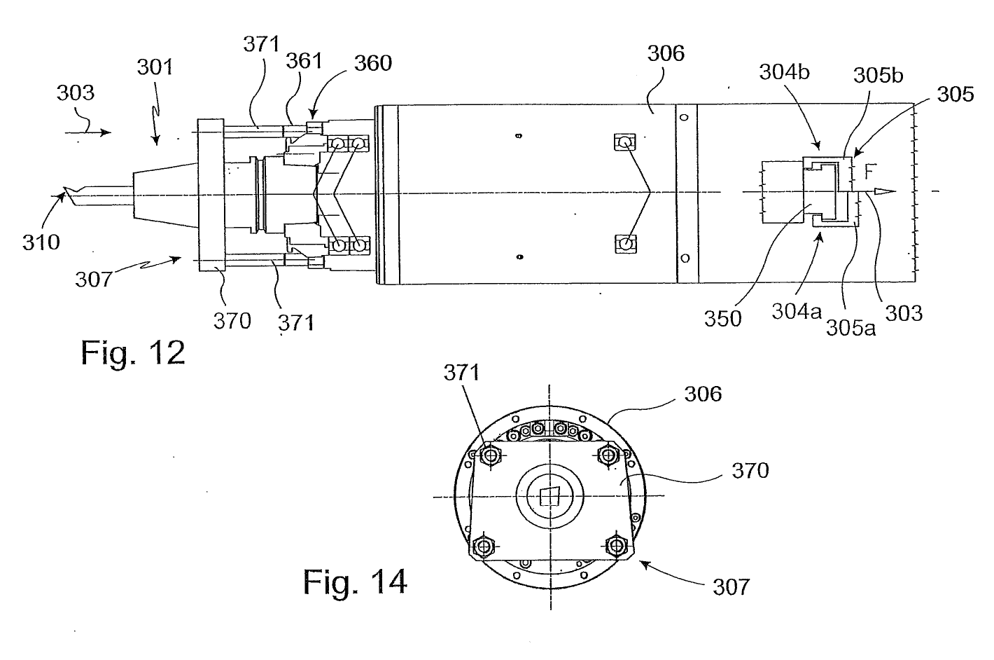

FIG. 14 in a top view the front face of the tool spindle of the machine tool according to the invention of FIG. 12.

In the figures identical or corresponding elements each are indicated by the same reference numbers, and therefore are, if not useful, not described anew.

FIG. 1 shows the invention schematically. The machine tool 1 comprises, on the one hand, a work piece table 3, holding the work piece 2. FIG. 1 does not show the machining tool designed, for example, as drill or milling cutter, driven by a tool spindle and moving in an appropriate way relatively to the work piece 2. The machine tool 1 according to the invention has a number of axes. For a machining as flexible as possible it is provided that the work piece 2 can be positioned relatively to the machining tool along the three spatial axes. Besides these longitudinal axes, however, also rotational axes are provided. A first rotational axis is indicated by reference number 10 and is called B-axis. It allows a rotation of the work piece table 3 around a horizontally orientated rotational axis 10. The arrangement is here chosen in such a way that the work piece table 3 has a console 30 arranged, for example, on one side on a sledge or pillar 12. If the design is sledge-like, for example, a motion in vertical direction (rectangular to the axis 10) is possible.

Furthermore, it is provided that the work piece 2 can rotate around another rotational axis 11, orientated vertically in FIG. 1. As the orientation of this rotational axis depends on the position of the console 30 around the rotational axis 10, of course, the second rotational axis 11 (called, for example, A-axis) is not determined, however, it is rectangular to the first axis 10.

For rotating the work piece 2 around the second axis 11, on the machine tool 1 a preferably electrically designed rotational drive 13 is provided. The example of FIGS. 1 and 10 shows the rotational function of the work piece table 3 around different spatial axes 10, 11. Of course, the embodiment of a machine tool according to the invention can also be realized when such a rotational function is not or only partially provided, that means, the work piece table 3 can move only along the longitudinal axes or is fixed completely, that means it is designed stationarily. In this respect the invention is free in the distribution of the different motion or rotational axes to the positioning of the work piece 2 or the machining tool.

It is pointed out, that the design according to the invention can be realized with machine tools 1 that are equipped, as shown, with a rotational function of the work piece table 3 around different spatial axes 10, 11, as well as also with machine tools that do not have such a rotational function, i.e. for example, they can only move along the longitudinal axes or be fixed completely, that means stationarily.

In this respect the invention is free in the distribution of the different motion or rotational axes to the positioning of the work piece or the machining tool.

Instead of the console-like (30) design of the work piece table 3 shown here, of course, also a portal-like design is possible.

The work piece 2 to be machined is clamped on a supporting slab 42, that is part of the work piece table 3, by means of the clamping device 4.

The design of the invention shown in FIG. 1 is chosen in such a way that the clamping device 4 comprises several clamping elements 40, 40′. The single clamping elements 40, 40′ are basically designed identically, and have a laterally projecting clamping claw 41, 41′ provided longitudinally moving on the clamping element. The clamping claw 41, 41′ engages on the appropriate positions on the work piece, and presses it on the supporting slab 42. Besides this direct connection, it is, of course, also possible that the clamping claw holds the work piece indirectly, for example, when the work piece 2 is attached to a work piece carrier or pallet or the like.

The clamping claw 41 is longitudinally moving, rectangular to the plane of the supporting slab 42. This longitudinal movement is realized by a spindle drive in the clamping element 40 where the clamping claw 41 is part of a spindle nut running on a driven spindle. Coaxially to this spindle, a toothed wheel 43 is provided that is connected via a chain or another means 53 for power transmission with a central drive 55. The design is here chosen such that all clamping elements are driven in the same way by the central drive, and an endlessly revolving chain 53 is provided as means for power transmission.

According to the invention, as central drive an electromotor 5 is provided, equipped with an appropriate driving pinion and/or a gear, and thus drives the chain or another means 53 for power transmission.

It is convenient here, that, by reversing the rotational direction of the electromotor, the opening and closing motion of the claw 41, 41′ can be influenced.

The construction of the electric motor 5 is standard, a motor shaft projecting from the housing of the electromotor 5 acts as rotor, and carries appropriate elements for the transmission of the turning moment, moment of momentum or power, such as, for example, a pinion, driving pinion, gear or the like.

In the example shown here, an electromotor 5 is provided as central drive acting on several clamping elements 40, 40′. In an alternative concept according to the invention, however, it is also provided that each single clamping element has a direct drive, and thus each single clamping element is associated with its electromotor.

A central part of the invention here is the use of an electromotor in the immediate vicinity of the work piece 2. The motor shaft 50 driven by the electromotor 5 acts here as directly as possible, for example via the motor shaft itself, via a gear, another means for power transmission, or via a hydraulic line on the clamping element, and imprints appropriate clamping power in this in such a way, that the work piece is held reliably.

Between the spindle in the clamping element 40 and the chain drive, a sliding clutch is provided in which the clamping power of the clamping element can be limited. The clamping power is here maintained by a self-locking gear, a self-locking motor or another brake.

Through monitoring the current consumption of the electromotor, it is now possible here to monitor cleverly and separately the single clamping states of the clamping elements 40.

Also a free wheel is provided on the claw drives by means of the spindles and the pinions, to accomplish a releasing of the clamping elements.

Cleverly, between the electromotor 5 and the single clamping elements 40, 40′ of the clamping device 4, also a gear is provided that allows a translation of the increase of the turning moment.

It is also an essential advantage of the invention, that on the motor shaft 50 an adapter fitting 51 is provided, and the entire supporting slab 42 can be removed in a single way from the work piece table 3, and thus in the adapter fitting 51, for example, a lathe chuck can be inserted in which then another work piece 2 can be clamped.

In the example of FIG. 1 the machine tool according to the invention is shown with resting work piece 2. The work piece 2 to be machined is here clamped on a supporting slab 42 by means of the clamping device 4. This supporting slab 42 is part of clamping device 4 that can be exchanged or removed from the work piece table 3 in the machine tool 1 according to the invention. The clamping device 4 on the supporting slab 42 has several clamping elements 40, 40′. The single clamping elements 40, 40′ are designed essentially identically, and have a laterally projecting clamping claw 41, 41′ provided longitudinally moving on the clamping element 40, 40′. The clamping claw 41, 41′ engages in defined positions on the work piece 2, and pushes it during machining to the supporting slab 42. Besides this direct connection, it is, of course, also possible that the clamping claw 41, 41′ holds the work piece 2 indirectly, for example, when the work piece 2 is fastened to a work piece carrier or a pallet or the like. Below the work piece 2 supporting blocks 44a are arranged on the supporting slab 42 providing a supporting point 44b with defined supporting position for the work piece 2. The supporting blocks 44a are also attached to the supporting slab 42. The supporting slab 42 again is supported on the work piece table 3 or the work piece carrier 33 through the supporting points 46a.

The clamping claws 41, 41′ are longitudinally movable rectangular to the surface of the supporting slab 42. This longitudinal motion is realized, for example, by a spindle drive in the clamping element 40, 40′, where the clamping claws 41, 41′ are parts of spindle nuts running on a driven spindle. Coaxially on these spindles, toothed wheels 43 are provided connected via a means 53 for power transmission with a central drive 55. The means 53 for power transmission can be provided, for example, as chain or the like. The design and guide of the means 53 for transmission is chosen here such that all clamping elements 40, 40′ are driven in the same way by the central drive 55. The central drive 55 again is in connection via a motor shaft connecting piece 52 with a driving motor 5 providing the driving power that is designed preferably as electric motor 5a or hydraulic motor 5b. This driving motor 5 drives a drive shaft 50 connected via an adapter fitting 51 with the motor shaft connecting piece 52 of the central drive 55 of the clamping device 4. The driving motor 5 serves, in the example of FIG. 1, as drive for the clamping device 4. The central drive 55 connected with the driving motor 5 has accordingly a driving pinion and/or gear effecting a power transmission from the driving motor 5 to the means 53 for power transmission. It is convenient here that by a reversing of the rotational direction of the driving motor 5, the opening and closing movement of the clamping claws 41, 41′ can be influenced. The central drive 55 as well as the means 53 for power transmission and the driving pinions and/or the gear 54 are here received in the supporting slab 42, and designed as a unit that can be removed on demand from the work piece table 3 or the work piece carrier 33. By releasing the central drive 55 from the drive shaft 50 of the driving motor 5, the entire clamping device 4, that means the supporting slab 42 containing the central drive 55, the means 53 for power transmission and the appropriate drive pinions or the gear, the clamping elements 40, 40′ arranged on it as well as the clamping claws 41, 41′ provided on it can be removed from the machine tool 1 or the work piece 3. After removing the clamping device 4 it is only the work piece carrier 33 with the rotary table 32 provided in it that remains on the work piece table 3. Centrally arranged in the rotary table 32 is the adapter fitting 51 that is available optionally for the arrangement of the clamping device 4 or a lathe or jaw chuck 6. The adapter fitting 51 is located here between the supporting points 46a or in the surface 47 limited by them. It is an advantage of the machine tool 1 that as central part of the invention the use of a motor, preferably an electric motor 5a, or hydraulic motor 5b is provided in the immediate vicinity to the work piece 2. The drive shaft 50 driven by the motor 5 acts here as directly as possible, for example, via the drive shaft 50 itself, via a gear, another means 53 for power transmission or via a hydraulic line on the clamping device that can be connected to the machine tool on demand, and imprints a corresponding clamping power in the clamping elements 40, 40′ of the clamping device 4, so that the work piece 2 can be held reliably. Alternatively to the power transmission from drive 5 to the drive shaft 50, an additional gear 54 can be provided.

In the clamping device between the spindle in the clamping element 40, 40′ (not shown) and the chain drive, that means the central drive 55 and the means 53 for power transmission connected with it or the toothed wheels associated with the clamping elements 40, 40′ or other elements, a sliding clutch is provided in which the clamping power of the clamping element 40, 40′ can be restricted. The clamping power is here maintained by a self-locking gear, a self-locking motor or another brake.

By monitoring the power consumption of the driving motor it is possible to monitor the single clamping states of the clamping elements 40, 40′, and to influence them accordingly. A free wheel is provided on the claw drives as well as on the gear pinions to achieve the reopening of the clamping elements 40, 40′.

The complete clamping device 4 can be removed from the work piece table so that on the work piece table 3 only the rotary table 32 of the work piece carrier 33 as well as the drive shaft 50 and the drive motor 5 associated with it remains, and for arranging of other, alternative elements the machine tool according to the invention is available. A lathe or jaw chuck 6, in which a work piece 2 can be clamped, can be arranged through the adapter fitting 51. The machine tool 1 according to the invention therefore makes a resetting from milling machining to turning on a lathe machining and vice versa possible on short notice.

FIGS. 2a, 2b show the supporting plate 42 in a top view (FIG. 2a) and a bottom view (FIG. 2b). On the underside of the supporting slab 42 the connecting piece 52 for the motor shaft can be seen. It has several lateral catches 54 engaging in the corresponding recess of the adapter fitting 51 of the motor shaft 50 (see FIG. 1), and thus transmit the turning moment.

The rotation of the motor shaft 50 sets also the pivoted supported connecting piece 52 of the motor shaft in rotation. The connecting piece 52 for the motor shaft then drives directly or, if necessary, via a gear a means 53 for power transmission, here, for example, a chain or a roller chain. This chain 53 is guided over the toothed wheels of the single clamping elements 40, and drives it in the same direction. Additionally, the connecting piece 52 for the motor shaft also drives a drive wheel 44 of another, differently designed clamping element 40a. This may be, for example, a so-called zero point clamping device that carries out an exact positioning of the work piece or the work piece carrier/pallet carrying the work piece. It has been mentioned, that as a means 53 for power transmission not only mechanically acting elements are provided, but also again a hydraulically driven clamping device is provided. This does not contradict in any way the idea of the invention! As it can be seen clearly in FIG. 2b, the clamping element 40a driven hydraulically, is on the same rotational plane as the work piece, that means these two elements are not anymore twisted against each other, a rotary division system, that has to be sealed expensively, is not necessary here, the hydraulic piping is rather simple. On the other hand, the design of a zero point clamping device as component is standardized and equipped with an hydraulic impingement function. It is an advantage of the invention, that through the electric motor 5 suggested according to the invention also a (small) hydraulic pump can be driven that then is provided and employed for the hydraulically driven clamping element 40a as zero point clamping device. The driving wheel 44 acts here in a suitable way on this small hydraulic pump.

It must be also mentioned that by a clever guiding of the claw in the clamping element, for example in a connecting link guide, the claw can also carry out a rotary motion. The machine tool according to the invention is often loaded and unloaded automatically, and the claw has then to be removed at the same time out of the motion space of the work piece to be fed or removed. Monitoring the rotating motions of the electromotor therefore also monitors the position of the single clamping claws 41, and, because of the restricted guidance, an arrangement of this type is also operationally reliable.

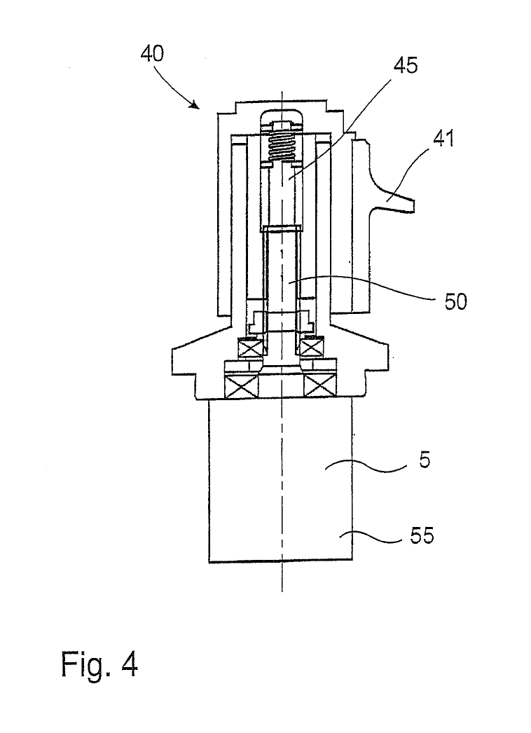

FIG. 4 shows an exemplary construction of a clamping element 40 where an electromotor 5 is connected as direct drive 55. The motor shaft directly drives the spindle 45 of the clamping element, the claw 41 is located above a spindle nut on the spindle 45.

FIG. 3 shows an alternative modification for the clamping element 40. Again in the clamping element an extra electromotor 5 acting as direct drive 55 is associated acting via an angular gear 56 on the spindle 45.

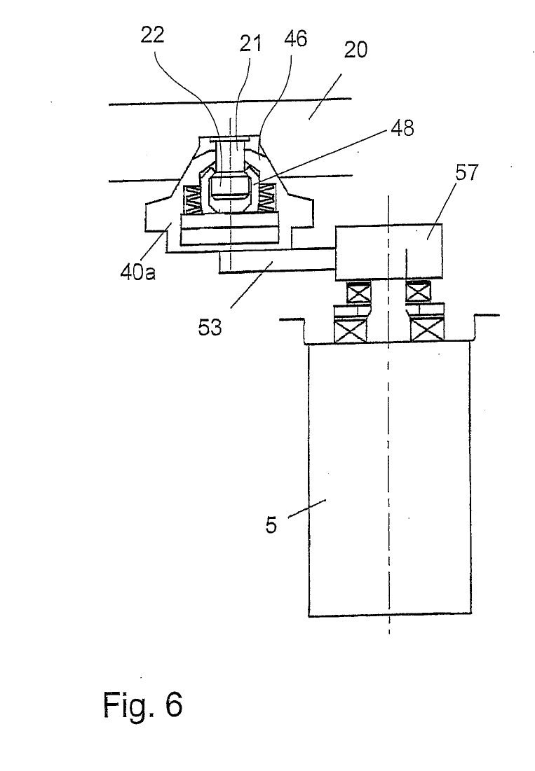

FIG. 6 shows another alternative modification of the clamping element 40a. The not shown work piece 2 is arranged on a work piece carrier 20 or a pallet 20, and exactly fixed on it. The work piece carrier 20 has on its underside at least one pin 21 projecting in the clamping element 40a.

The clamping element 40a has collet chucks 46 which grip behind the pin head 22. Operation of the collet chucks 46 is now carried out preferably hydraulically. The means 53 for power transmission is here the hydraulic medium under corresponding working pressure; the electromotor 5 suggested according to the invention therefore acts on a hydraulic pump 57 generating an appropriate pressure level.

FIG. 5 shows in a detailed view the lathe or jaw chuck 6. As described, the suggestion according to the invention allows removing the supporting slab 42 from the work piece table 3. At the end of the motor shaft 50 opposite the motor, there is the adapter fitting 51. In this the connecting piece 52 of the motor shaft of the lathe or jaw chuck 6 projects in the same way.

The lathe or jaw chuck 6 is, by the way, designed as usual, and allows a radial gripping of the work piece 2. If necessary, additional means for connecting or fastening are provided to fasten the jaw chuck 6 on the motor shaft 50 or the work piece table 3.

The lathe or jaw chuck 6 of FIG. 5 comprises, in the embodiment of FIG. 5, a chuck body 260 that can be connected fixedly with the rotary table 232 (see FIG. 10), and serves as receiver for the rotating spindle 261 of the lathe or jaw chuck 206. The spindle 261 is, in the example of FIG. 10, supported via two bearings 265 in the interior of the chuck body, and has on its bottom end facing in mounted condition the work piece table 203 or the rotary table 232 a motor shaft connecting piece 252. This motor shaft connecting piece 252 is engaged during mounting of the chuck with the adapter fitting 251 of the drive shaft 250 so that a direct drive of the spindle 261 can be carried out. On its top end opposite the motor shaft connecting piece 252 the spindle 261 has jaws 264 serving for clamping a work piece 202 in or at the spindle 261. The lathe or jaw chuck 206 shown here can be designed as two, three or multiple jaw chuck, and thus provides a plurality of clamping options for different work pieces 202. Arranged in the chuck body 60, there are two bearings 65 shown highly schematically in FIG. 5. These may be a ball, slide or rolling bearing. The part of the spindle 61 projecting beyond the chuck body 60 has additionally projections 67 gripping over the upper edge 66 of the chuck body 60 through which the centering of the spindle 61 in the chuck body 60 is improved. Thus a highly accurate machining of the mounted work pieces 2 is possible. The chuck body 60 can be connected with the rotary table 32 via appropriate holding means (not shown in FIG. 5). The holding means are here designed in such a way that also with a high number of revolutions and thus large forces acting on the lathe or jaw chuck 6, a permanent and reliably positioned connection of the lathe or jaw chuck 6 to the rotary table 32 is secured. The supporting surfaces 68 between the chuck body 60 and the rotary table 32 are here chosen sufficiently large to guarantee this fit. The rotary table 32 can serve in a simpler embodiment of the lathe or jaw chuck 6, that is only connected with the drive shaft 50, as sliding surface 256 for the rotating chuck supported without other fastening on the rotary table.

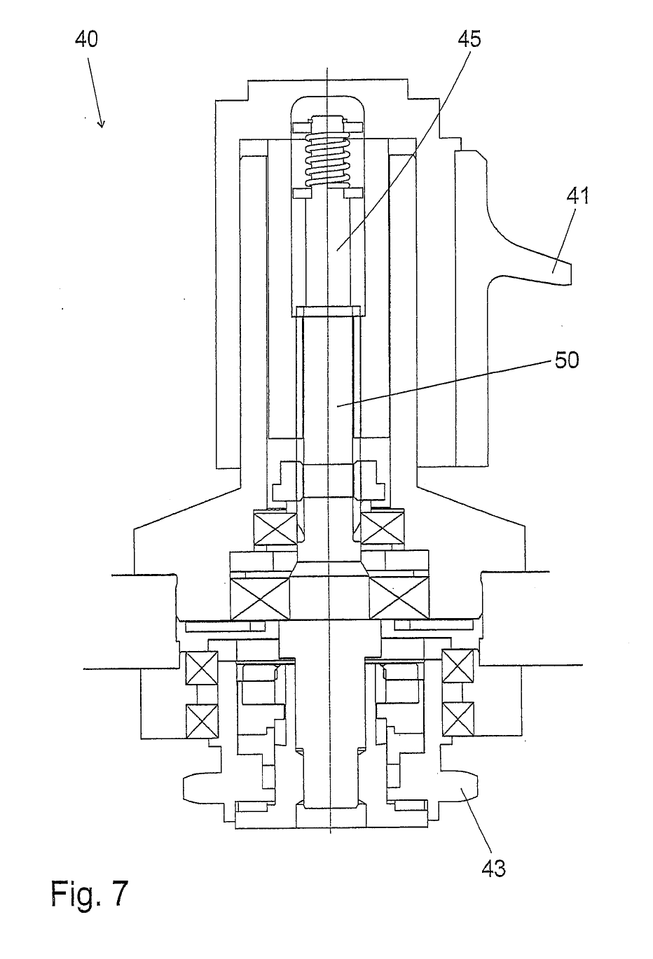

FIG. 7 shows another embodiment of the clamping element according to the invention. In contrast to the already presented modifications, here below the clamping element 40 there is a toothed wheel 43 designed as chain pinion at which, for example, a chain engages as means 53 for power transmission. All other reference numbers correspond with already presented reference numbers so that presenting them again is not necessary.

FIG. 8 shows in a side view another embodiment of a machine tool according to the invention with zero point clamping. Here only a part of the machine tool is shown that makes clear how here the clamping means are employed in interaction with a zero point clamping. The zero point clamping device serves, as already mentioned, for exact positioning or orientation of the work piece 2 at or on the machining surface. In the presented case of FIG. 8, reference surfaces 7 are provided on the clamping elements. These reference surfaces 7 serve for making the exact positioning of the work piece or a pallet 2a carrying the work piece easier. Because of these reference surfaces it can be determined, whether the work piece 2 is positioned exactly or not.

The work piece 2 has on its side facing the clamping device clamping nipples 8. These clamping nipples 8 are embraced by collet chucks 46. In the collet chucks 46 also, as described previously, clamping clasps 48 are arranged serving for an additional improvement of the clamping of the clamping nipple 8. This design allows making the clamping process very exactly by combining here the advantages of the zero point clamping with the advantages of the electric mechanic clamping. Instead of an arrangement on the work piece 2, the clamping nipple 8 can also be arranged on a pallet 2a carrying the work piece. This pallet 2a is shown schematically in FIG. 9.

In FIG. 9 a detail of FIG. 8 is shown through which it can be seen that on the clamping nipple 8 a data carrier 9 is provided. Instead of the work piece 2, here a pallet 2a carrying the work piece 2 is shown schematically. The data carrier 9 can be designed either as transponder or as bar code or as another means for transmitting information. This data carrier 9 contains information about the work piece 2 to be machined as well as favorably also information about the machining of the work piece so that, after clamping, the control recognizes immediately which machining has to be carried out, and initiates the appropriate control processes.

FIG. 10 shows another preferred embodiment of the machine tool according to the invention. This comprises the parts and functions already described in connection with FIG. 1. Instead of the clamping device 4 shown there the machine tool 201 shown in FIG. 10 has a lathe or jaw chuck 6, 206 arranged on the work piece table 203 or the work piece carrier 233, shown in FIG. 5. This is supported on the rotary table 232 provided in the work piece carrier 233 via supporting points 246b. The lathe or jaw chuck 206 has a motor shaft connection piece 252 inserted in a recess 234 in the rotary table 232 and connected with an adapter fitting 251 of the drive shaft 250. A transmission of power is then carried out via this from the driving motor 205 also received in the work piece table 203. Besides the use of an electromotor 205a as driving motor 205 there is also, of course, the option of providing here a hydraulic motor 205b as drive 205 for the drive shaft 250 or the lathe or jaw chuck 206 arranged on it. The lathe or jaw chuck 206 has a chuck body 260 that is fixedly connected with the rotary table 232, preferably screwed in it or clamped together with it in another suitable way. Bearings 265 through which the spindle 261 of the lathe or jaw chuck 206 are supported pivoted in the chuck body 260 are provided in the chuck body 260. The bearings 265 are shown schematically in the example of FIG. 10, and can be designed as ball, slide or rolling bearing or in any other suitable way. Jaws 264 for clamping the work piece 202 are arranged in the spindle 261. There is also the option with reference to the jaws 264 of providing very different forms of jaws as well as different numbers of jaws on the spindle 261.

As described before in connection with FIG. 1, the machine tool 201 according to the invention allows removing of the supporting slab 242 with the clamping device 4 arranged on it from the work piece table 203. At the end of the drive shaft 250 distanced from the drive motor 205, the free adapter fitting 251 is located after the supporting slab 242 has been removed. In this the motor shaft connection piece 252 of the lathe or jaw chuck 206 projects in the same way, and can be connected via appropriate connecting means with the drive shaft 250.

By the way, the lathe or jaw chuck 206 is designed as usual, and allows a radial gripping of the work piece 202. As shown in FIG. 10, the chuck body 260 of the lathe or jaw chuck 206 is supported on the rotary table 232 of the work piece table 203, and is connected to it in a suitable way with additional connection or fastening means. Besides, however, there is also the option that the rotary table 232 provides a sliding surface 256 for the chuck body 260, and no separate spindle 261, supported in the chuck body 261, is provided, but clamping of the work piece 202 is carried out directly via the jaw 264 guided for the chuck body 260.

Rotating the drive shaft 250 sets the pivoted supported spindle 261 in rotation. A stationary tool that may be provided in the machine tool 201, for example a lathe tool or caulker, can be angled towards the work piece 202 and removes then material. By a corresponding change of position of the tool, then a corresponding machining of the work piece 202 can be carried out. During angling the tool towards the work piece 202, its positioning can also be carried out by an appropriate orientation of the work piece table via the rotational axes 210, 211 so that a perfect orientation of the work piece 202 with respect to the tool is given. By means of this then the perfect machining position is defined, and the flexibility of the machine tool 201 according to the invention is enhanced.

The invention is described, among others, in connection with a drive commonly referred to as electromotor 205. This can be a synchronous, asynchronous or direct current motor. The synchronous motor can be configured as sensorless synchronous motor, and here as permanent magnet-excited synchronous motor, and allow a sensorless rotor position or standstill position recognition.

In FIGS. 11, 12 and 13 in the right area in the respective drawing, each time two different positions are shown and indicated by the letters a and b. One embodiment according to the invention has the purpose of realizing two fields of use or ways of use with the machine tool described here. For this, in the tool spindle 306, in particular on the side opposite the machining tool 301 (in FIGS. 11, 12, 13 on the right hand side), a separate drive is provided the adjusting element of which is indicated by reference number 305, and is synonymously also used for the drive. The figure shows schematically the two different positions of the adjustment element 305. In the top section (with reference to the center axis 363), the standard position 304b is shown; in the bottom section, the fixed position 304a of the machining tool 301 is shown. The drive 305 or its adjusting element 305 is also shown in two different positions 305a, 305b. In the position 304a, the adjustment element 305a, designed C-shaped in section, grips behind the tension element 350 designed on its end like a hammer head. The tension element 350 is connected with built-in parts, not shown in detail, that finally operate a clamping element of the clamping device, and thus hold the machining tool 301 in the tool mount 302. The pull-back motion of the tension element 350 to the right is indicated by operative direction 303. The operative direction 303 effects finally also that the machining tool 301 is drawn in the front area of the spindle 306 or to the right. The drive shown schematically in the drawing and indicated by reference number 305 can have different embodiments. Thus, the drive 305 can be designed as electromotor or hydraulic motor and drive, respectively. The electromotor itself can be mounted in embodiments as synchronous, asynchronous or direct current motor, wherein the use of a sensorless synchronous or asynchronous motor presents essential advantages with respect to the rotor position or standstill position recognition as well as with respect to the structural dimensions.

In the embodiments shown in FIG. 11, the machining tool 301 is put back by the movement of the drive 305 in such a way that its tool mount 302 exercises an axial force on the pivot or rolling bearing 320. The tool base 311 is here inserted in the tool mount 302, the elements of the clamping device are shown only schematically, the tool mount 302 is pivoted on bearings around the rotational/longitudinal axis 363 in the rolling bearing or pivot bearing 320. Shifted to the right by the force F resulting from the drive 5 in operative direction 303, a corresponding axial force is created in the pivot bearing 320 that leads to a compensation of the free rotary motion, and a fixing of the pivot bear 320 or the rotational motion. However, if the rotational motion of the pivot bearing 320 is removed, the machining tool 301 is not able anymore to rotate, and is thus also fixed.

In the example shown in FIG. 11 the machining tool 301 is fixed indirectly via the fixing of the pivot bearing 320.

FIGS. 12, 14 and 13, respectively, however, show even another modification where the machining tool 301 itself is fixed, i.e. directly or immediately by the position of the tension element 350, caused by the drive 305.

The machining tool 301 carries here a supporting device 307 formed by a supporting plate or supporting collar 370 slid on the machining tool. The dimension of this supporting plate 370 is larger than the diameter of the tool shank of the machining tool 301. On the side of the supporting plate 370 opposite the tool tip 310, the supporting device 307 has several supporting elements 371, for example supporting pins 371 that are supported next to the tool mount on the spindle head 360 on a supporting area 361 or supporting ring 361 in axial direction.

The machining tool 301 is fixed here in the direction of the circumference (with respect to the rotational axis 363) through friction of the supporting elements 371 on the supporting area 361. To reach, a better turning moment support, in FIG. 13 an improvement is suggested according to the invention. A turning moment support 372 is realized on the lower supporting pin 371. This is formed by positive locking projecting of the end of the supporting pin 371 opposite the supporting plate 370 in a boring 362 of the supporting area 361.

The claims filed with the application now and to be filed later on are attempted formulations without prejudice for obtaining a broader protection.

If here on closer examination, in particular also of the relevant prior art, it turns out that one or the other feature may be convenient for the object of the invention, however not decisively important, of course, already now a formulation is striven for that does not contain anymore such a feature, in particular in the main claim.

Furthermore, it has to be taken into consideration that the embodiments and modifications of the invention described in the different examples and shown in the figures can be combined with each other in any way. Here single or several characteristics can be exchanged at will. These combinations of characteristics are also disclosed.

References in the sub-claims refer to the further design of the matter of the main claim through the characteristics of the respective sub-claim. These are, however, not to be understood as a waiver of independent subjective protection of the matter for the characteristics of the referred sub-claims.

Characteristics only disclosed in the description so far may be now, in the course of proceedings, be claimed as being of inventive relevance, for example to distinguish from the state of the art.

Characteristics only disclosed in the description or even characteristics of claims comprising a number of characteristics may be taken over in the first claim at any time to distinguish from the state of the art, and this is even if such characteristics have been mentioned in connection with other characteristics, and achieve particularly convenient results in connection with other characteristics, respectively.

1. A machine tool for machining at least one work piece, the machine tool comprising:
a machining tool for machining the at least one work piece, the machining tool being one of non-rotatable or rotatably driven by a tool spindle;
a tool mount for the machining tool;
a tool clamping device comprising at least one tool clamping element for directly or indirectly attaching a machining tool to the tool mount;
a work piece table rotatable about at least two rotational axes and translatable along one longitudinal axis;
a work piece clamping device for holding, directly or indirectly, the at least one work piece on or at the work piece table; and
at least one electromotor, the generated force (F), turning moment and/or angular momentum of which act indirectly or directly on the at least one work piece.

2. The machine tool according to claim 1, wherein the force (F) and/or the turning moment of the electromotor is transferred via a gear, a chain, an arrangement of pinions, least one toothed wheel, or an angular gear to the at least one work piece and/or the work piece clamping device.

3. The machine tool according to claim 1, wherein the electromotor is stationarily integrated in the work piece table.

4. The machine tool according to claim 1, wherein the work piece table comprises a console or a portal, wherein the console or the portal is arranged on a sledge or a pillar of the machine tool.

5. The machine tool according to claim 1, wherein the work piece table is rotatable about a first horizontal rotational axis and a second vertical rotational axis.

6. The machine tool according to claim 1, wherein the electromotor is arranged as a central drive acting on several work piece clamping elements of the work piece clamping device.

7. The machine tool according to claim 1, wherein a clamping force that can be impressed on the work piece clamping element and/or the at least one work piece is limited by a friction clutch, and/or is maintained by a self-locking gear, a self-locking electromotor or a brake.

8. The machine tool according to claim 1, further comprising a gear disposed between the electromotor and the work piece clamping device, the gear having a gear ratio that increases the turning moment provided.

9. The machine tool according to claim 1, wherein the work piece clamping device comprises at least one work piece clamping element interacting indirectly or directly with the at least one work piece, and wherein the electromotor is in operative connection with the at least one work piece clamping element and is provided for generating the clamping force.

10. The machine tool according to claim 9, wherein control of the clamping force is provided through the motor current received by the electromotor.

11. The machine tool according to claim 9, wherein the work piece clamping device is configured with separate work piece clamping elements, as a vice or as a chuck with three or more jaws.

12. The machine tool according to claim 9, wherein the at least one work piece clamping element have laterally protruding clamping claws.

13. The machine tool according to claim 12, wherein the at least one work piece clamping element have a spindle drive for longitudinal movement of the clamping claws.

14. The machine tool according to claim 1, further comprising a work piece carrier for carrying the at least one work piece or a pallet for holding the work piece clamping device.

15. The machine tool according to claim 1, wherein the machining tool is positioned relative to the at least one work piece held on the work piece table.

16. The machine tool according to claim 1, wherein the machining tool is attached to the tool spindle for rotation thereabout, and can be angled with respect to the at least one work piece.

17. The machine tool according to claim 1, wherein the at least one electromotor is provided to enable rotation of the at least one work piece for rotational grinding or turning machining.

18. The machine tool according to claim 9, further comprising a motor shaft drivable by the at least one electromotor.

19. The machine tool according to claim 18, wherein the motor shaft is in operative connection directly with the at least one work piece clamping element via a gear or a power transmission device.

20. The machine tool according to claim 18, wherein the motor shaft comprises an adapter fitting for connecting the motor shaft with a power transmission device for the work piece clamping device or the at least one work piece clamping element or for connecting the motor shaft with a lathe chuck enabling the indirect or direct receipt of the at least one work piece, thereby enabling rotational cutting or turning machining of the at least one the work piece.

21. The machine tool according to claim 9, wherein each of the at least one electromotor is a rotational drive for a respective one of the at least one work piece clamping element.

22. The machine tool according to claim 1, wherein the tool clamping device is provided with an electromotor for generating clamping force of the tool clamping device, wherein the electromotor is in indirect or direct connection with the at least one tool clamping element.
